(19) United States
(12) Patent Application Publication
(10) Pub. No.: US 2024/0385591 A1
(43) Pub. Date: Nov. 21, 2024

(54) Industrial Data Integration Device, Method and Computer Readable Storage Medium

(71) Applicant: Siemens Aktiengesellschaft, München (DE)

(72) Inventors: Zhi Qiang Yu, Qingdao (CN); Lu Wang, Qingdao (CN); Zhan Bin Yang, Qingdao (CN); Wen Qing Qiu, Qingdao (CN); Qi Yu, Nanjing (CN)

(73) Assignee: Siemens Aktiengesellschaft, München (DE)

(21) Appl. No.: 18/692,111

(22) PCT Filed: Sep. 15, 2021
(86) PCT No.: PCT/CN2021/118567

§ 371 Date: Mar. 14, 2024

(51) Int. Cl. G05B 19/4155

(52) U.S. Cl. CPC G05B 19/4155; G05B 2219/31449

(57) ABSTRACT

Various embodiments of the teachings herein include an industrial data integration device. An example device includes: a first interaction module to interact with a first industrial field device based on a non-standard protocol; a life cycle management module to manage a life cycle of the first interaction module; and a service discovery module to discover a first service provided by the first interaction module. The first service is related to an interaction between the first interaction module and the first industrial field device.

### CROSS-REFERENCE TO RELATED APPLICATIONS

This application is a U.S. National Stage Application of International Application No. PCT/CN2021/118567 filed Sep. 15, 2021, which designates the United States of America, the contents of which are hereby incorporated by reference in their entirety.

### TECHNICAL FIELD

The present disclosure relates to the field of industrial technology. Various embodiments of the teachings herein may include industrial data integration devices and/or methods.

### BACKGROUND

For the industrial field, there are a large number of different types of equipment with different operating protocol interfaces. Even in an industrial automation production line, it is composed of several different devices, and each device has its own proprietary data exchange protocol interface.

The industry's decision-making process is based on global data from most underlying devices (rather than individual devices). Therefore, the main problem is how to integrate those different devices (including existing devices and even later additional devices (smart and non-smart devices)) and how to collect and analyze data, and so on. Due to the variety of data exchange protocol interfaces, it is impossible for the upper business layer to understand and develop all the data exchange protocol interfaces to interact with various bottom devices to collect data. At the same time, considering the possibility of adding new equipment and replacing old equipment or malfunctioning equipment in the future, it is also necessary for the upper business layer to make dynamic changes to adapt to the new protocol interface. The effort and cost to keep changing is huge.

On the one hand, international standards may standardize interface protocols and recommend equipment manufacturers to follow these standards. For example, the OPC UA standard is a well-known industrial data exchange standard that allows easy and secure exchange of information between different platforms from multiple vendors and allows seamless integration of these platforms without the need for expensive and time-consuming software development. Although many manufacturers support the OPC UA standard, especially those world-renowned manufacturers, there are still many manufacturers that do not support the OPC UA standard and use its proprietary interface protocol in their products.

On the other hand, one may collect data from the underlying equipment that is standardized on the interface protocol and supported by the upper business layer. For example, one may only collect data from devices that support Modbus RTU, Modbus TCP, and OPC UA. This solution leads to sub-optimal decisions, and sometimes even wrong ones because the decision is only based on partial data of those special equipment. In addition, the solution reduces the flexibility of enterprise choice.

For those devices with non-standardized interface protocols, there are two options to choose from. The first option is to add a standardized wrapper on the device, such as an OPC UA wrapper. The wrapper implements the OPC UA standard, and then it can interoperate with other standardized OPC UA systems. The wrapper acts as a converter, which converts the device proprietary interface protocol format and the OPC UA format in both directions. This option requires the equipment to allow the addition of a wrapper, but it is usually impossible to change the existing equipment in the industrial field. The second option is to replace devices with non-standardized interface protocols and use smart devices that already support the OPC UA standard, but the cost is very high.

### SUMMARY

The teachings of the present disclosure include industrial data integration devices and methods to address these challenges. For example, some embodiments include an industrial data integration device (100), comprising: a first interaction module (101), configured to interact with a first industrial field device based on a non-standard protocol; a life cycle management module (102), configured to manage a life cycle of the first interaction module (101); and a service discovery module (103), configured to discover a first service provided by the first interaction module (101), where the first service is related to the interaction between the first interaction module (101) and the first industrial field device.

Some embodiments further comprise a second interaction module (104), configured to interact with a second industrial field device based on a standard protocol; wherein the life cycle management module (102) is further configured to manage a life cycle of the second interaction module (104); the service discovery module (103) is further configured to discover a second service provided by the second interaction module (104), wherein the second service is related to the interaction between the second interaction module (104) and the second industrial field device.

Some embodiments further comprise a service providing module (105), configured to register the first service or the second service, and provide the registered first service or the registered second service via a Web server.

In some embodiments, the life cycle management module (102) is configured to receive configuration information of the first interaction module (101), wherein the configuration information of the first interaction module (101) includes a first description field with a first general data structure and a second description field with a second general data structure, the first description field describing the first service provided by the first interaction module (101) and a third service required by the first interaction module (101), the second description field describing a basic information of the first interaction module (101) and callback functions related to the life cycle of the first interaction module (101); determine the first service and the third service by parsing the first description field; determine basic information of the first interaction module (101) and callback functions related to the life cycle of the first interaction module (101) by parsing the second description field; and manage the life cycle of the first interaction module (101) by using the basic information of the first interaction module (101) and the callback functions related to the life cycle of the first interaction module (101); and the service discovery module (103) is configured to establish a first mapping relationship between the first service and the third service, and initiate a registration process for the first service according to the basic information of the first interaction module (101) and the first mapping relationship.

In some embodiments, the life cycle management module (102) is configured to receive configuration information of the first interaction module (101), wherein the configuration information of the first interaction module (101) includes a first description field with a first general data structure and a second description field with a second general data structure, the first description field describing the first service provided by the first interaction module (101) and a third service required by the first interaction module (101), the second description field describing a basic information of the first interaction module (101) and callback functions related to the life cycle of the first interaction module (101); determine the first service and the third service by parsing the first description field; determine basic information of the first interaction module (101) and callback functions related to the life cycle of the first interaction module (101) by parsing the second description field; and manage the life cycle of the first interaction module (101) by using the basic information of the first interaction module (101) and the callback functions related to the life cycle of the first interaction module (101); the service discovery module (103) is configured to establish a first mapping relationship between the first service and the third service, and initiate a registration process for the first service according to the basic information of the first interaction module (101) and the first mapping relationship; wherein the life cycle management module (102) is configured to receive configuration information of the second interaction module (104), wherein the configuration information of the second interaction module (104) includes a third description field with the first general data structure and a fourth description field with the second general data structure, the third description field describing the second service provided by the second interaction module (104) and a fourth service required by the second interaction module (104), the fourth description field describing a basic information of the second interaction module (104) and callback functions related to the life cycle of the second interaction module (104); determine the second service and the fourth service by parsing the third description field; determine basic information of the second interaction module (104) and callback functions related to the life cycle of the second interaction module (104) by parsing the fourth description field; and manage the life cycle of the second interaction module (104) by using the basic information of the second interaction module (104) and the callback functions related to the life cycle of the second interaction module (104); the service discovery module (103) is configured to establish a second mapping relationship between the second service and the fourth service, and initiate a registration process for the second service according to the basic information of the second interaction module (104) and the second mapping relationship.

Some embodiments include an authentication module (106), configured to perform authentication processing on a requesting party requesting access to the registered first service or the registered second service.

Some embodiments include a storage module (107), configured to store persistently a first industrial data obtained by the first interaction module (101) from the first industrial field device and a second industrial data obtained by the second interaction module (104) from the second industrial field device, in a memory; and a data analysis module (108), configured to perform data analysis on the first industrial data and the second industrial data in the memory in response to a data analysis request received via the Web server.

As another example, some embodiments include an industrial data integration method (600) comprising: enabling a first interaction module to interact with a first industrial field device based on a non-standard protocol (601); managing a life cycle of the first interaction module (602); and discovering a first service provided by the first interaction module, where the first service is related to the interaction between the first interaction module and the first industrial field device (603).

Some embodiments include: enabling a second interaction module to interact with a second industrial field device based on a standard protocol; managing a life cycle of the second interaction module; and discovering a second service provided by the second interaction module, wherein the second service is related to the interaction between the second interaction module and the second industrial field device.

Some embodiments include: registering for the first service or the second service; and providing registered first service or registered second service via web server.

Some embodiments include: receiving configuration information of the first interaction module, wherein the configuration information of the first interaction module includes a first description field with a first general data structure and a second description field with a second general data structure, the first description field describing the first service provided by the first interaction module and a third service required by the first interaction module, the second description field describing a basic information of the first interaction module and callback functions related to the life cycle of the first interaction module; determining the first service and the third service by parsing the first description field; determining basic information of the first interaction module and callback functions related to the life cycle of the first interaction module by parsing the second description field; managing the life cycle of the first interaction module by using the basic information of the first interaction module and the callback functions related to the life cycle of the first interaction module; establishing a first mapping relationship between the first service and the third service; and initiating a registration process for the first service according to the basic information of the first interaction module and the first mapping relationship.

Some embodiments include: receiving configuration information of the first interaction module, wherein the configuration information of the first interaction module includes a first description field with a first general data structure and a second description field with a second general data structure, the first description field describing the first service provided by the first interaction module and a third service required by the first interaction module, the second description field describing a basic information of the first interaction module and callback functions related to the life cycle of the first interaction module; determining the first service and the third service by parsing the first description field; determining basic information of the first interaction module and callback functions related to the life cycle of the first interaction module by parsing the second description field; managing the life cycle of the first interaction module by using the basic information of the first interaction module and the callback functions related to the life cycle of the first interaction module; establishing a first mapping relationship between the first service and the third service; initiating a registration process for the first service according to the basic information of the first interaction module and the first mapping relationship; receiving configuration information of the second interaction module, wherein the configuration information of the second interaction module includes a third description field with the first general data structure and a fourth description field with the second general data structure, the third description field describing the second service provided by the second interaction module and a fourth service required by the second interaction module, the fourth description field describing a basic information of the second interaction module and callback functions related to the life cycle of the second interaction module; determining the second service and the fourth service by parsing the third description field; determining basic information of the second interaction module and callback functions related to the life cycle of the second interaction module by parsing the fourth description field; managing the life cycle of the second interaction module by using the basic information of the second interaction module and the callback functions related to the life cycle of the second interaction module; establishing a second mapping relationship between the second service and the fourth service; and initiating a registration process for the second service according to the basic information of the second interaction module and the second mapping relationship.

Some embodiments include performing authentication processing on a requesting party requesting access to the registered first service or the registered second service.

Some embodiments include: storing persistently a first industrial data obtained by the first interaction module from the first industrial field device and a second industrial data obtained by the second interaction module from the second industrial field device, in a memory; and performing data analysis on the first industrial data and the second industrial data in the memory in response to a data analysis request received via the Web server.

As another example, some embodiments include an industrial data integration device (700), comprising a processor (701) and a memory (702), wherein an application program executable by the processor (701) is stored in the memory (702) for causing the processor (701) to execute one or more of the industrial data integration methods (600) as described herein.

As another example, some embodiments include a computer-readable medium comprising computer-readable instructions stored thereon, including instructions for executing one or more industrial data integration methods (600) as described herein.

### BRIEF DESCRIPTION OF THE DRAWINGS

In order to make technical solutions of examples of the present disclosure clearer, accompanying drawings to be used in description of the examples will be simply introduced hereinafter. The accompanying drawings to be described hereinafter are only some examples of the present disclosure. Those skilled in the art may obtain other embodiments according to these accompanying drawings without creative labor.

FIG. 1 is a structural diagram of an example industrial data integration device incorporating teachings of the present disclosure;

FIG. 2 is a schematic diagram of an example industrial data integration device deployed in a cluster mode incorporating teachings of the present disclosure;

FIG. 3 is a schematic diagram of an example industrial data integration device deployed in a central mode incorporating teachings of the present disclosure;

FIG. 4 is a flowchart of an example life cycle management and service discovery process incorporating teachings of the present disclosure;

FIG. 5 is a flow chart for acquiring device status incorporating teachings of the present disclosure;

FIG. 6 is a flowchart of an example industrial data integration method incorporating teachings of the present disclosure; and

FIG. 7 is a structural diagram of an example industrial data integration device with a processor-memory architecture incorporating teachings of the present disclosure.

### LIST OF REFERENCE NUMBERS

| reference numbers | meanings |
|---|---|
| 100 | industrial data integration device |
| 101 | first interaction module |
| 102 | life cycle management module |
| 103 | service discovery module |
| 104 | second interaction module |
| 105 | service providing module |
| 106 | authentication module |
| 107 | storage module |
| 108 | data analysis module |
| 10 | upper buisness layer |
| 20 | management node |
| 31; 41 | field monitoring node |
| 30 | integration node |
| 29 | industrial data integration device |
| 28 | persistent storage |
| 27 | operating system and basic software |
| 26 | message communication module |
| 25 | web server |
| 24 | storage module |
| 23 | data analysis module |
| 22 | service providing module |
| 21 | authentication module |
| 32 | industrial data integration device |
| 33 | life cycle management module |
| 34 | service discovery module |
| 35 | non-standard field device |
| | interaction module |
| 36 | Socket interaction module |
| 37 | Ros interaction module |
| 38 | message communication module |
| 39 | operating system and basic software |
| 42 | industrial data integration device |
| 43 | life cycle management module |
| 44 | service discovery module |
| 45 | OPC UA module |
| 48 | message communication module |
| 49 | operating system and basic software |
| 51 | industrial field device based on |
| | non-standard protocol |
| 52 | Socket-based industrial field device |
| 53 | Ros-based industrial field device |
| 54 | RS323/485 based industrial field |
| | device |
| 55 | OPC UA-based industrial field |
| | device |
| 61 | output data access interface |
| 62 | Socket server |
| 63 | Ros server |
| 64 | industrial data integration device |
| 65 | OPC UA server |
| 641 | RS323/485 module |
| 642 | message communication module |
| 643 | RS323/485 gateway |
| 80 | life cycle management module |
| 81 | service discovery module |
| 82 | non-standard field device connection |
| | module |
| 83 | Socket interaction module |
| 85 | Ros interaction module |
| 90 | device based on non-standard |
| | protocols |
| 91 | Socket-based device |
| 92 | Ros-based device |
| 93 | output data access interface |
| 94 | Socket server |
| 95 | Ros server |
| 400 | administrator |
| 401~420 | steps |
| 500 | web user |
| 501~522 | steps |
| 600 | industrial data integration method |
| 601~603 | steps |
| 700 | industrial data integration device |
| 701 | processor |
| 702 | memory |

### DETAILED DESCRIPTION

Some embodiments of the teachings herein include an industrial data integration device comprising: a first interaction module, configured to interact with a first industrial field device based on a non-standard protocol; a life cycle management module, configured to manage a life cycle of the first interaction module (101); a service discovery module, configured to discover a first service provided by the first interaction module, where the first service is related to the interaction between the first interaction module and the first industrial field device.

Such an apparatus presents an industrial data integration device as a middleware platform in the industrial field, which can discover services provided by industrial field devices based on non-standard protocols, and shields the heterogeneity of industrial field devices. Moreover, online hot update is also realized.

Some embodiments include a second interaction module, configured to interact with a second industrial field device based on a standard protocol; wherein the life cycle management module is further configured to manage a life cycle of the second interaction module; the service discovery module is further configured to discover a second service provided by the second interaction module, wherein the second service is related to the interaction between the second interaction module and the second industrial field device. Therefore, the industrial data integration device can also discover the services provided by industrial field devices based on standard protocols.

Some embodiments include a service providing module, configured to register the first service or the second service, and provide the registered first service or the registered second service via a Web server. The first service or the second service can be registered and provided through Web server, and the Web server can provide a unified interface for upper business layer.

In some embodiments, the life cycle management module is configured to receive configuration information of the first interaction module, wherein the configuration information of the first interaction module includes a first description field with a first general data structure and a second description field with a second general data structure, the first description field describing the first service provided by the first interaction module and a third service required by the first interaction module, the second description field describing a basic information of the first interaction module and callback functions related to the life cycle of the first interaction module; determine the first service and the third service by parsing the first description field; determine basic information of the first interaction module and callback functions related to the life cycle of the first interaction module by parsing the second description field; and manage the life cycle of the first interaction module by using the basic information of the first interaction module and the callback functions related to the life cycle of the first interaction module; the service discovery module is configured to establish a first mapping relationship between the first service and the third service, and initiate a registration process for the first service according to the basic information of the first interaction module and the first mapping relationship.

Through the first description field with the first general data structure, the registration process for the first service can be realized, and by the second description field with the second general data structure, the life cycle management for the first interaction module can be realized.

In some embodiments, the life cycle management module is configured to receive configuration information of the first interaction module, wherein the configuration information of the first interaction module includes a first description field with a first general data structure and a second description field with a second general data structure, the first description field describing the first service provided by the first interaction module and a third service required by the first interaction module, the second description field describing a basic information of the first interaction module and callback functions related to the life cycle of the first interaction module; determine the first service and the third service by parsing the first description field; determine basic information of the first interaction module and callback functions related to the life cycle of the first interaction module by parsing the second description field; and manage the life cycle of the first interaction module by using the basic information of the first interaction module and the callback functions related to the life cycle of the first interaction module; the service discovery module is configured to establish a first mapping relationship between the first service and the third service, and initiate a registration process for the first service according to the basic information of the first interaction module and the first mapping relationship; wherein the life cycle management module is configured to receive configuration information of the second interaction module, wherein the configuration information of the second interaction module includes a third description field with the first general data structure and a fourth description field with the second general data structure, the third description field describing the second service provided by the second interaction module and a fourth service required by the second interaction module, the fourth description field describing a basic information of the second interaction module and callback functions related to the life cycle of the second interaction module; determine the second service and the fourth service by parsing the third description field; determine basic information of the second interaction module and callback functions related to the life cycle of the second interaction module by parsing the fourth description field; and manage the life cycle of the second interaction module by using the basic information of the second interaction module and the callback functions related to the life cycle of the second interaction module; the service discovery module is configured to establish a second mapping relationship between the second service and the fourth service, and initiate a registration process for the second service according to the basic information of the second interaction module and the second mapping relationship.

Therefore, through the first description field with the first general data structure, a unified registration process for the first service and the second service can be realized. Through the second description field with the second general data structure, a unified life cycle management for the first interaction module and the second interaction module can be realized. A unified configuration is realized for industrial field equipment that adopts standard protocols or non-standard protocols.

In some embodiments, there is an authentication module to perform authentication processing on a requesting party requesting access to the registered first service or the registered second service. The authentication processing of the requesting party is also realized, which improves the security.

In some embodiments, there is a storage module, configured to store persistently a first industrial data obtained by the first interaction module from the first industrial field device and a second industrial data obtained by the second interaction module from the second industrial field device, in a memory; a data analysis module, configured to perform data analysis on the first industrial data and the second industrial data in the memory in response to a data analysis request received via the Web server. Therefore, data storage services and data analysis services are also provided.

In some embodiments, an industrial data integration method includes: enabling a first interaction module to interact with a first industrial field device based on a non-standard protocol; managing a life cycle of the first interaction module; discovering a first service provided by the first interaction module, where the first service is related to the interaction between the first interaction module and the first industrial field device. This realizes an industrial data integration device as a middleware platform in the industrial field, which can discover services provided by industrial field devices based on non-standard protocols and shields the heterogeneity of industrial field devices. Moreover, online hot update is also realized.

In some embodiments, the method includes: enabling a second interaction module to interact with a second industrial field device based on a standard protocol; managing a life cycle of the second interaction module; discovering a second service provided by the second interaction module, wherein the second service is related to the interaction between the second interaction module and the second industrial field device. Therefore, the industrial data integration device can also discover the services provided by industrial field devices based on standard protocols.

In some embodiments, the method includes registering for the first service or the second service; providing registered first service or registered second service via web server. The first service or the second service can be registered and provided through Web server, and the Web server can provide a unified interface for upper business layer.

In some embodiments, the method includes: receiving configuration information of the first interaction module, wherein the configuration information of the first interaction module includes a first description field with a first general data structure and a second description field with a second general data structure, the first description field describing the first service provided by the first interaction module and a third service required by the first interaction module, the second description field describing a basic information of the first interaction module and callback functions related to the life cycle of the first interaction module; determining the first service and the third service by parsing the first description field; determining basic information of the first interaction module and callback functions related to the life cycle of the first interaction module by parsing the second description field; managing the life cycle of the first interaction module by using the basic information of the first interaction module and the callback functions related to the life cycle of the first interaction module; establishing a first mapping relationship between the first service and the third service; initiating a registration process for the first service according to the basic information of the first interaction module and the first mapping relationship. Through the first description field with the first general data structure, the registration process for the first service can be realized, and by the second description field with the second general data structure, the life cycle management for the first interaction module can be realized.

In some embodiments, the method includes: receiving configuration information of the first interaction module, wherein the configuration information of the first interaction module includes a first description field with a first general data structure and a second description field with a second general data structure, the first description field describing the first service provided by the first interaction module and a third service required by the first interaction module, the second description field describing a basic information of the first interaction module and callback functions related to the life cycle of the first interaction module; determining the first service and the third service by parsing the first description field; determining basic information of the first interaction module and callback functions related to the life cycle of the first interaction module by parsing the second description field; managing the life cycle of the first interaction module by using the basic information of the first interaction module and the callback functions related to the life cycle of the first interaction module; establishing a first mapping relationship between the first service and the third service; initiating a registration process for the first service according to the basic information of the first interaction module and the first mapping relationship; receiving configuration information of the second interaction module, wherein the configuration information of the second interaction module includes a third description field with the first general data structure and a fourth description field with the second general data structure, the third description field describing the second service provided by the second interaction module and a fourth service required by the second interaction module, the fourth description field describing a basic information of the second interaction module and callback functions related to the life cycle of the second interaction module; determining the second service and the fourth service by parsing the third description field; determining basic information of the second interaction module and callback functions related to the life cycle of the second interaction module by parsing the fourth description field; managing the life cycle of the second interaction module by using the basic information of the second interaction module and the callback functions related to the life cycle of the second interaction module; establishing a second mapping relationship between the second service and the fourth service; initiating a registration process for the second service according to the basic information of the second interaction module and the second mapping relationship. Therefore, through the first description field with the first general data structure, a unified registration process for the first service and the second service can be realized. Through the second description field with the second general data structure, a unified life cycle management for the first interaction module and the second interaction module can be realized. A unified configuration is realized for industrial field equipment that adopts standard protocols or non-standard protocols. In some embodiments, the method includes performing authentication processing on a requesting party requesting access to the registered first service or the registered second service. It can be seen that the authentication processing of the requesting party is also realized, which improves the security.

In some embodiments, the method includes: storing persistently a first industrial data obtained by the first interaction module from the first industrial field device and a second industrial data obtained by the second interaction module from the second industrial field device, in a memory; performing data analysis on the first industrial data and the second industrial data in the memory in response to a data analysis request received via the Web server. Therefore, data storage services and data analysis services are also provided.

As another example, some embodiments include an industrial data integration device comprising a processor and a memory, wherein an application program executable by the processor is stored in the memory for causing the processor to execute one or more industrial data integration methods as described herein.

As another example, some embodiments include a computer-readable medium comprising computer-readable instructions stored thereon for executing one or more industrial data integration methods asd described herein.

To make the technical solutions and advantages of the present disclosure more comprehensible, the teachings will be further described in detail below with reference to the accompanying drawings and embodiments. The specific embodiments described herein are merely illustrative and are not intended to limit the scope of the disclosure. For the sake of brevity and clarity of the description, below the description includes several representative embodiments. Numerous details in the embodiments are only configured to assist in understanding the aspects of the present disclosure. However, the technical solutions can be implemented without being limited to these details.

To avoid unnecessarily obscuring aspects thereof, some embodiments are not described in detail, but only the framework is given. Hereinafter, “including” means “including but not limited to”, and “according to” means “at least according to”, but not limited to only based on “. Due to the language habit of Chinese, the number of one component is not specifically indicated below, which means that the component may be one or more, or may be understood as at least one.

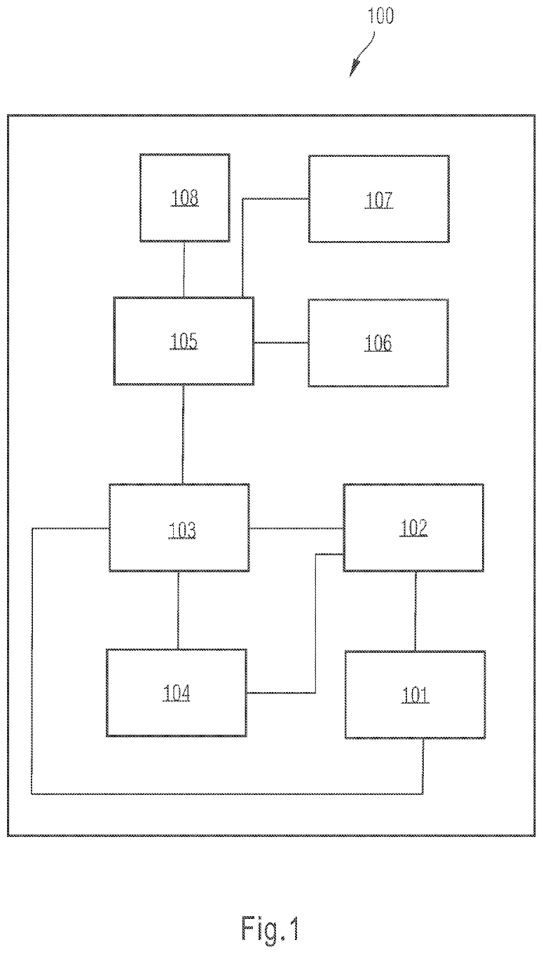

FIG. 1 is a structural diagram of an industrial data integration device incorporating teachings of the present disclosure. As shown in FIG. 1, the industrial data integration device 100 includes: a first interaction module 101, which is used to interact with a first industrial field device (not shown in FIG. 1) based on a non-standard protocol; a life cycle management module 102, which is used to manage the life cycle of the first interaction module 101; and a service discovery module 103 is used to discover a first service provided by the first interaction module 101, where the first service is related to the interaction between the first interaction module 101 and the first industrial field device.

Non-standard protocols are industrial data exchange protocols that do not comply with international standards. It can be seen that this embodiment realizes an industrial data integration device as a middleware platform in the industrial field, which can discover services provided by industrial field devices based on non-standard protocols, and shields the heterogeneity of industrial field devices. Moreover, since the service discovery module supports the discovery of the first service provided by the first interaction module, online hot updates are also realized.

In some embodiments, the industrial data integration apparatus 100 may further include: a second interaction module 104, which is used to interact with a second industrial field device based on a standard protocol; wherein the life cycle management module 102 is also used to manage the life cycle of the second interaction module 104. The service discovery module 103 is also used to discover a second service provided by the second interaction module 104, where the second service is related to the interaction between the second interaction module 104 and the second industrial field device. Therefore, the industrial data integration device can also discover the services provided by industrial field devices based on standard protocols. Among them, the standard protocol may include OPC UA protocol, Modbus protocol, Ros protocol or Socket protocol, etc. The first industrial field device and the second industrial field device can be implemented as Edge devices, PLCs, sensors, actuators, etc., respectively.

In some embodiments, the life cycle management module 102 is configured to receive configuration information of the first interaction module 101, wherein the configuration information of the first interaction module 101 includes a first description field with a first general data structure and a second description field with a second general data structure, the first description field describing the first service provided by the first interaction module 101 and a third service required by the first interaction module 101, the second description field describing a basic information of the first interaction module 101 and callback functions related to the life cycle of the first interaction module 101; determine the first service and the third service by parsing the first description field; determine basic information of the first interaction module 101 and callback functions related to the life cycle of the first interaction module 101 by parsing the second description field; and manage the life cycle of the first interaction module 101 by using the basic information of the first interaction module 101 and the callback functions related to the life cycle of the first interaction module 101; the service discovery module 103 is configured to establish a first mapping relationship between the first service and the third service, and initiate a registration process for the first service according to the basic information of the first interaction module 101 and the first mapping relationship. Through the first description field with the first general data structure, the registration process for the first service can be realized, and by the second description field with the second general data structure, the life cycle management for the first interaction module can be realized.

In some embodiments, the life cycle management module 102 is configured to receive configuration information of the first interaction module 101, wherein the configuration information of the first interaction module 101 includes a first description field with a first general data structure and a second description field with a second general data structure, the first description field describing the first service provided by the first interaction module 101 and a third service required by the first interaction module 101, the second description field describing a basic information of the first interaction module 101 and callback functions related to the life cycle of the first interaction module 101; determine the first service and the third service by parsing the first description field; determine basic information of the first interaction module 101 and callback functions related to the life cycle of the first interaction module 101 by parsing the second description field; and manage the life cycle of the first interaction module 101 by using the basic information of the first interaction module 101 and the callback functions related to the life cycle of the first interaction module 101; the service discovery module 103 is configured to establish a first mapping relationship between the first service and the third service, and initiate a registration process for the first service according to the basic information of the first interaction module 101 and the first mapping relationship.

The life cycle management module 102 is configured to receive configuration information of the second interaction module 104, wherein the configuration information of the second interaction module 104 includes a third description field with the first general data structure and a fourth description field with the second general data structure, the third description field describing the second service provided by the second interaction module 104 and a fourth service required by the second interaction module 104, the fourth description field describing a basic information of the second interaction module 104 and callback functions related to the life cycle of the second interaction module 104; determine the second service and the fourth service by parsing the third description field; determine basic information of the second interaction module 104 and callback functions related to the life cycle of the second interaction module 104 by parsing the fourth description field; and manage the life cycle of the second interaction module 104 by using the basic information of the second interaction module 104 and the callback functions related to the life cycle of the second interaction module 104; the service discovery module 103 is configured to establish a second mapping relationship between the second service and the fourth service, and initiate a registration process for the second service according to the basic information of the second interaction module 104 and the second mapping relationship.

Therefore, through the first description field with the first general data structure, a unified registration process for the first service and the second service can be realized. Through the second description field with the second general data structure, a unified life cycle management for the first interaction module and the second interaction module can be realized. A unified configuration is realized for industrial field equipment that adopts standard protocols or non-standard protocols. For example, the first general data structure can be specifically implemented as an XML file format, including the following structure:

```
<Module>
  <Name>...</Name>
  <Type>...</Type>
  <ProvidedInterfaces>
    <Interface>...</Interface>
    <...></...>
  </ProvidedInterfaces>
  <ConsumedInterfaces>
    <Interface>...</Interface>
    <...></...>
  </ConsumedInterfaces>
  <...>...<...>
</Module>
```

Among them, the provided services are described in the <ProvidedInterfaces> section, and the required services are described in the <ConsumedInterfaces> section.

The second general data structure can also be specifically implemented as an XML file format, or as an embedded code format, including the following structure:

```
Module Structure
{
  name,
  type,
  connected device info,
  Lifecycle reference,
  ...
}
Module Lifecycle
{
  create,
  start,
  execute,
  stop,
  destroy,
  ...
}
```

Among them, the basic information of the module includes module name (name), module type (type), connected device information (connected device info), and so on. The callback functions related to the life cycle include: create module command (create), start module command (start), execute module command (execute), stop module command (stop) and destroy module command (destroy), etc.

The foregoing describes typical examples of the first general data structure and the second general data structure. Those skilled in the art may realize that this description is only exemplary and is not used to limit the protection scope of the present disclosure.

In some embodiments, the industrial data integration device 100 further includes a service providing module 105 for registering the first service or the second service and providing the registered first service or the registered second service via Web server. The first service or the second service can be registered, and the registered first service and the registered second service can be provided through the web server, and a web server that provides a unified interface for the upper business layer is realized.

In some embodiments, the industrial data integration device 100 includes an authentication module 106 for performing authentication processing on a requester requesting to access the registered first service or the registered second service. It can be seen that the authentication processing of the requesting party is also realized, and the security is improved.

In some embodiments, the industrial data integration device 100 includes: a storage module 107 for acquiring a first industrial data obtained by the first interaction module 101 from the first industrial field device and a second interaction module 104 from the second industrial field device The second industrial data in the memory is persistently stored in the memory; the data analysis module 108 is configured to perform data analysis on the first industrial data and the second industrial data in the memory in response to a data analysis request received via the Web server. Therefore, data storage services and data analysis services are also provided.

This embodiment describes a modular industrial data integration solution. A middleware platform is implemented for the industrial field, which can connect the underlying industrial field devices (such as Edge, PLC, sensors, actuators, etc.) with the upper business layer. The platform includes basic system-level modules and customized user-level modules. The system-level module provides a runtime environment, which may include a message communication module, a life cycle management module, a service discovery module, and other system modules with specific functions. User-level modules can be customized by users or operators, and are mainly responsible for interacting with the underlying industrial field devices, such as collecting data from the device and sending control commands to the device. For example, there can be a 1:1 mapping relationship between user-level modules and industrial field devices.

The middleware platform provides module abstract lifecycle management interfaces (for example, Create, Start, Stop, Destroy) and abstract service interfaces (Provided Service, Consumed Service). Every user-level module needs to inherit to implement these abstract interfaces. The system-level lifecycle management module can dynamically load and unload custom user-level modules. The service discovery module can automatically discover which services the user-level module provides and consumes. In this way, the platform supports online hot updates and upgrades. Moreover, the middleware platform shields the heterogeneity of the underlying field devices and implements a web server that provides a unified access interface (such as a RESTful API) for the upper business layer.

The service discovery module automatically discovers all user services implemented in the user-level module when it dynamically loads the user-level module, and then registers all user services to the Web server. Therefore, the upper business layer will be able to understand all registered user services by accessing the Web server. From the perspective of the upper business layer, there is no need to develop a specific protocol to access the underlying equipment. All data can be obtained from the underlying equipment only by accessing the Web server. This method decouples the upper business layer from the bottom equipment and avoids major changes in the business layer.

For field devices with standard protocols, such as OPC UA and RS232/485 protocols, the platform has implemented local standard modules, which can be enabled only through configuration files according to actual needs. For field devices with proprietary protocols (non-standard protocols), it is necessary to follow the abstract interface specifications of the platform to implement customized modules to interact with field devices. These customized modules can be dynamically loaded into the system without shutting down.

The middleware platform supports two different deployment modes, namely cluster mode and central mode. In the cluster mode, it includes a management node and one or more field monitoring nodes. The management node mainly includes basic modules such as Web server and back-end service module, and is responsible for interacting with the upper business layer and other field monitoring nodes. The field monitoring node includes some basic modules and user-level modules, which are responsible for executing commands from the management node and interacting with the underlying field devices.

In the central mode, an integration node is included, which is responsible for interacting with the upper business layer and the underlying field devices.

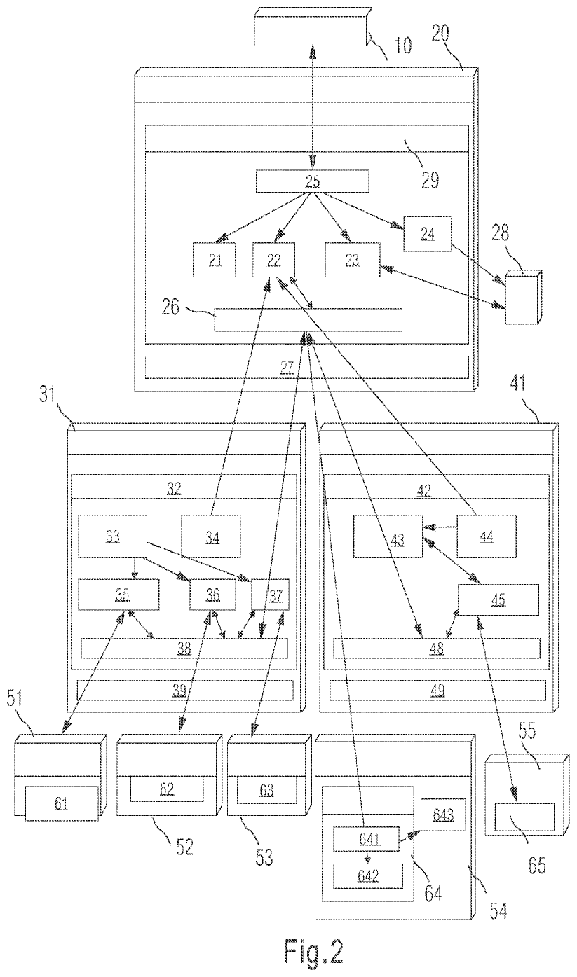

FIG. 2 is a schematic diagram of an industrial data integration device deployed in a cluster mode incorporating teachings of the present disclosure. In FIG. 2, the middleware platform includes a management node 20 and two field monitoring nodes 31 and 41. The management node 20 includes a web server 25 that provides a RESTful API. The Web server 25 is connected to the upper business layer 10. The management node 20 interacts with the upper business layer 10 and the field monitoring nodes 31 and 41 respectively.

The management node 10 includes an industrial data integration device 29 and an operating system and basic software 27. The industrial data integration device 29 also includes an authentication module 21, a service providing module 22, a data analysis module 23, a storage module 24, and a message communication module 26.

The field monitoring node 31 includes an industrial data integration device 32 and an operating system and basic software 39. The industrial data integration device 32 includes a life cycle management module 33, a service discovery module 34, a non-standard field device interaction module 35, a Socket interaction module 36, a Ros interaction module 37, and a message communication module 38. Among them, the non-standard field device interaction module 35 is connected with an industrial field device 51 based on the non-standard protocol; the Socket interaction module 36 is connected with a Socket-based industrial field device 52; the Ros interaction module 37 is connected with a Ros-based industrial field device 53.

The field monitoring node 41 includes an industrial data integration device 42 and an operating system and basic software 49. The industrial data integration device 42 includes a life cycle management module 43, a service discovery module 44, and an OPC UA module 45. Among them, the OPC UA module 45 is connected to an OPC UA-based industrial field device 55. The non-standard field device interaction module 35, the Socket interaction module 36, the Ros interaction module 37 and the OPC UA module 45 are all user-level modules.

In some embodiments, a field monitoring node may also be arranged in the field device. For example, an industrial data integration device 64 is arranged in an industrial field device 54 based on RS323/485. The industrial data integration device 64 includes an RS323/485 module 641 and a message communication module 642. The message communication module 642 is connected to the message communication module 26. The device 54 interacts with the management node 20 via the connection between the message communication module 642 and the message communication module 26.

The life cycle management module 33 in the field monitoring node 31 manages the life cycle of the non-standard field device interaction module 35 through a second description field included in the configuration information of the non-standard field device interaction module 35, wherein the second description field contains a second general data structure. Furthermore, the service discovery module 34 in the field monitoring node 31 determines a first service provided by the non-standard field device interaction module 35 via a first description field included in the configuration information of the non-standard field device interaction module 35, wherein the first service is provided by the non-standard field device interaction module 35 and the first description field contains a first general data structure. The first service is based on the interaction data between the non-standard field device interaction module 35 and the output data access interface 61 in the device 51. The service discovery module 34 registers the first service with the service providing module 22. The service providing module 22 provides the registered first service to the upper business layer 10 via the Web server 25.

The life cycle management module 33 in the field monitoring node 31 manages the life cycle of the Socket interaction module 36 through a fourth description field included in the configuration information of the Socket interaction module 36, where the fourth description field contains the second general data structure. Moreover, the service discovery module 34 in the field monitoring node 31 determines a second service provided by the Socket interaction module 36 via a third description field included in the configuration information of the Socket interaction module 36, where the third description field contains the first general data structure. The second service is based on the interaction data between the Socket interaction module 36 and the server 62 in the device 52. The service discovery module 34 registers the second service with the service providing module 22. The service providing module 22 provides the registered second service to the upper business layer 10 via the Web server 25.

Similarly, the upper business layer 10 can access the services provided by the Ros interaction module 37. Similarly, the upper business layer 10 can access the services provided by the OPC UA module 45.

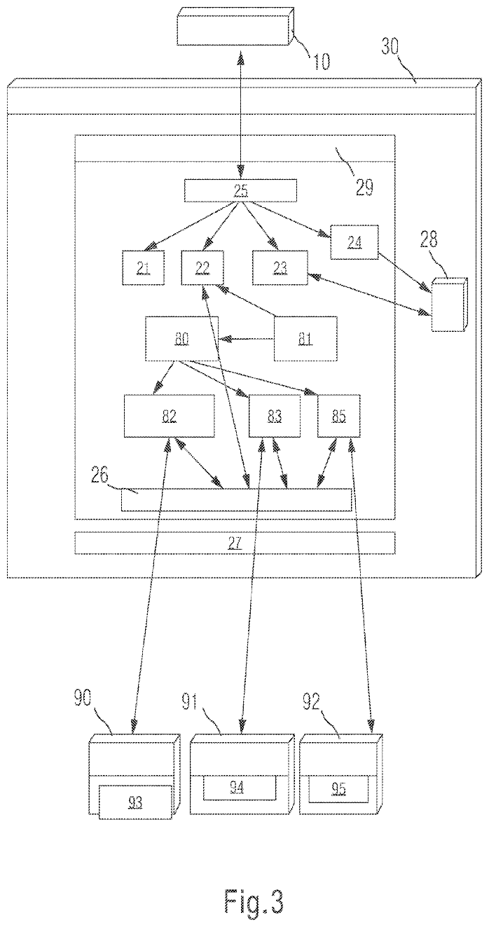

FIG. 3 is a schematic diagram of an industrial data integration device deployed in a central mode incorporating teachings of the present disclosure. In FIG. 3, the industrial data integration device is integrated into the integration node 30. The integration node 30 includes an industrial data integration device 29 and an operating system and basic software 27. The industrial data integration device 29 includes a web server 25 that provides a RESTful API. The Web server 25 is connected to the upper business layer 10. The management node 20 interacts with the upper business layer 10 and the integration node 30 respectively.

The data integration device 29 includes: an authentication module 21, a service providing module 22, a data analysis module 23, a storage module 24, and a message communication module 26. The data integration device 29 also includes: a life cycle management module 80, a service discovery module 81, a non-standard field device connection module 82, a Socket interaction module 83, and a Ros interaction module 85. The non-standard field device connection module 82 is connected with a device 90 based on the non-standard protocol; the Socket interaction module 83 is connected with a Socket-based device 91; the Ros interaction module 37 is connected with a Ros-based device 92. The storage module 24 is connected to a persistent storage 28.

The life cycle management module 80 in the data integration device 29 manages the life cycle of the non-standard field device interaction module 82 through a second description field included in the configuration information of the non-standard field device interaction module 82, wherein the second description field contains the second general data structure. Moreover, the service discovery module 81 in the data integration device 29 determines the first service provided by the non-standard field device interaction module 82 via a first description field included in the configuration information of the non-standard field device interaction module 82. The first description field contains the first general data structure. The first service is based on the interaction data between the non-standard field device interaction module 82 and the output data access interface 93 in the device 90. The service discovery module 81 registers the first service with the service providing module 22. The service providing module 22 provides the registered first service to the upper business layer 10 via the Web server 25.

The life cycle management module 80 in the data integration device 29 manages the life cycle of the Socket interaction module 83 through a fourth description field included in the configuration information of the Socket interaction module 83, where the fourth description field contains the second general data structure. Moreover, the service discovery module 81 in the data integration device 29 determines a second service provided by the Socket interaction module 83 via a third description field included in the configuration information of the Socket interaction module 83. The third description field contains the first general data structure. The second service is based on the interaction data between the Socket interaction module 83 and the server 94 in the device 91. The service discovery module 81 registers the second service with the service providing module 22. The service providing module 22 provides the registered second service to the upper business layer 10 via the Web server 25.

Similarly, the upper business layer 10 can access the services provided by the Ros interaction module 85. Among them: the service provided by the Ros interaction module 85 is based on the interaction data between the Ros interaction module 85 and the ROS server 95 in the device 92.

In this embodiment, the modular data integration platform supports dynamic loading and unloading of user-level modules. This function depends on the life cycle management module. When the user-level module is dynamically loaded or unloaded from the platform, the system service discovery module will automatically discover all user services implemented in the user-level module, and then register and deregister these user services with the business module.

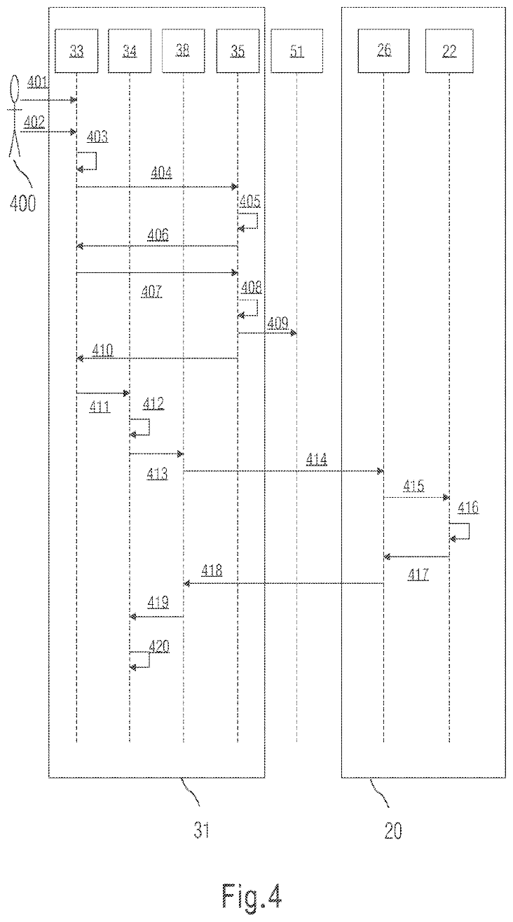

FIG. 4 is a flowchart of an example life cycle management and service discovery process incorporating teachings of the present disclosure. The method shown in FIG. 4 is applicable to the cluster mode of FIG. 2. As shown, the method includes:

Step 401: The administrator 400 sends a request to activate the life cycle management command line interface to the life cycle management module 33 in the field monitoring node 31.

Step 402: The administrator 400 sends a request loading module command to the life cycle management module 33, and provides configuration information in XML format. The configuration information includes the services provided by the non-standard field device interaction module 35 and the services required by the non-standard field device interaction module 35.

Step 403: The life cycle management module 33 parses the configuration information.

Step 404: The life cycle management module 33 provides the analysis result to the non-standard field device interaction module 35, and requests the non-standard field device interaction module 35 to create a module based on the request load module command.

Step 405: The non-standard field device interaction module 35 creates itself based on the analysis result, and initializes itself.

Step 406: The non-standard field device interaction module 35 notifies the life cycle management module 33 of the creation result.

Step 407: The life cycle management module 33 sends a request to run the module to the non-standard field device interaction module 35.

Step 408: The non-standard field device interaction module 35 starts to run.

Step 409: The non-standard field device interaction module 35 connects to the device 51 based on the non-standard protocol.

Step 410: The non-standard field device interaction module 35 notifies the life cycle management module 33 of the module status.

Step 411: The life cycle management module 33 sends the module status and module information to the service discovery module 34.

Step 412: The service discovery module 34 detects its own internal mapping table. The mapping relationship between each user-level module and the existing service is stored in the mapping table. Wherein, when it is found that there is no mapping relationship between the provided service in the configuration information and the module 35 in the mapping table, step 413 is executed.

Step 413: The service discovery module 34 sends a registration message for the service to the message communication module 38. This registered service is based on the interaction between the interaction module 35 and the device 51.

Step 414: The message communication module 38 forwards the registration message to the message communication module 26 in the management node 20.

Step 415: The message communication module 26 forwards the registration message to the service providing module 22.

Step 416: The service providing module 22 registers the service in its internal mapping table.

Step 417: The service providing module 22 notifies the message communication module 26 of the registration result.

Step 418: The message communication module 26 forwards the registration result to the message communication module 38.

Step 419: The message communication module 38 forwards the registration result to the service discovery module 34.

Step 420: The service discovery module 34 updates its own mapping table based on the registration result.

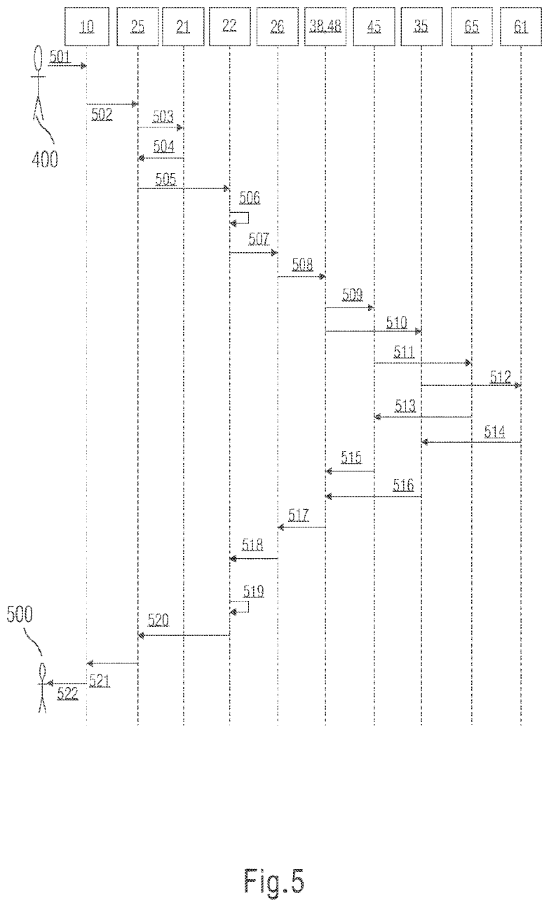

FIG. 5 is an exemplary flow chart of acquiring device status according to an embodiment of the present invention. The method shown in FIG. 5 is applicable to the cluster mode of FIG. 2.

In FIG. 5, the method includes:

Step 501: The administrator 400 sends a request to obtain the status of the device 51 and the device 55 to the upper service layer 10.

Step 502: The upper business layer 10 sends an http request for acquiring the status of the device 51 and the device 55 to the Web server 25.

Step 503: The Web server 25 sends an authentication request to the authentication module 21.

Step 504: The authentication module 21 returns the authentication result to the Web server 25.

Step 505: The Web server 25 forwards the http request for acquiring the status of the device 51 and the device 55 to the service providing module 22.

Step 506: The service providing module 22 parses the http request and checks the internal mapping table to find the respective user-level modules connected to the device 55 and the device 51 respectively. Among them, it is found that the device 55 is connected to the OPC UA module 45, and the device 51 is connected to the non-standard field device interaction module 35.

Step 507: The service providing module 22 generates a first request for the non-standard field device interaction module 35 and a second request for the OPC UA module 45, and sends the two requests to the message communication module 26 respectively.

Step 508: The message communication module 26 sends the first request to the message communication module 38, and sends the second request to the message communication module 48.

Step 509: The message communication module 48 sends the second request to the OPC UA module 45.

Step 510: The message communication module 38 sends the first request to the non-standard field device interaction module 35.

Step 511: The OPC UA module 45 accesses the OPC UA server 65 to obtain the working status of the device 55 based on the second request.

Step 512: The non-standard field device interaction module 35 accesses the output data access interface 61 to obtain the working status of the device 51 based on the first request.

Step 513: The OPC UA server 65 sends the working status of the device 55 to the OPC UA module 45.

Step 514: The output data access interface 61 sends the working status of the device 51 to the non-standard field device interaction module 35.

Step 515: The OPC UA module 45 sends the working status of the device 55 to the message communication module 48.

Step 516: The non-standard field device interaction module 35 sends the working status of the device 51 to the message communication module 38.

Step 517: The message communication module 48 sends the working status of the device 55 to the message communication module 26, and the message communication module 38 sends the working status of the device 51 to the message communication module 26.

Step 518: The message communication module 26 sends the working state of the device 51 and the working state of the device 55 to the service providing module 22.

Step 519: The service providing module 22 constructs an http response message including the working status of the device 51 and the working status of the device 55.

Step 520: The service providing module 22 sends the http response message to the Web server 25.

Step 521: The Web server 25 sends the http response message to the upper service layer 10.

Step 522: The web user 500 obtains the http response message from the upper service layer 10, and obtains the working status of the device 51 and the working status of the device 55 from the http response message.

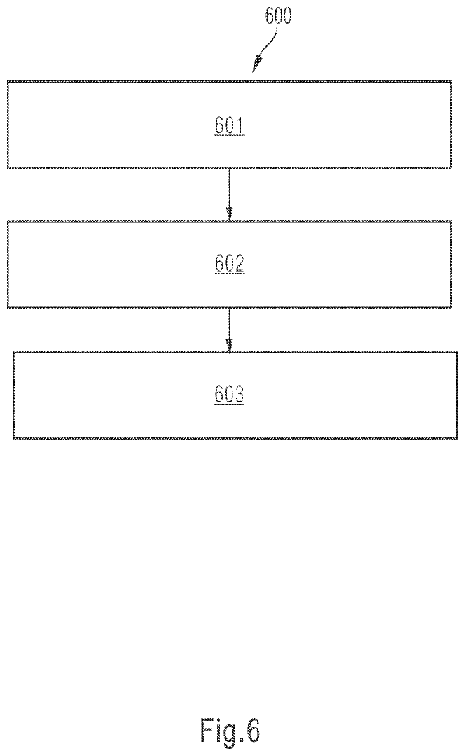

The embodiment of the present invention also proposes an industrial data integration method. FIG. 6 is a flowchart of an industrial data integration method according to an embodiment of the present invention.

As shown in FIG. 6, the industrial data integration method 600 includes:

Step 601: Enable the first interaction module to interact with the first industrial field device based on the non-standard protocol.

Step 602: Manage the life cycle of the first interaction module.

Step 603: Discover the first service provided by the first interaction module, where the first service is related to the interaction between the first interaction module and the first industrial field device.

In some embodiments, the method comprises: enabling a second interaction module to interact with a second industrial field device based on a standard protocol; managing a life cycle of the second interaction module; discovering a second service provided by the second interaction module, wherein the second service is related to the interaction between the second interaction module and the second industrial field device.

In some embodiments, the method comprises: registering for the first service or the second service; providing registered first service or registered second service via web server. The first service or the second service can be registered and provided through Web server, and the Web server can provide a unified interface for upper business layer.

In some embodiments, the method comprises: receiving configuration information of first the interaction module, wherein the configuration information of the first interaction module includes a first description field with a first general data structure and a second description field with a second general data structure, the first description field describing the first service provided by the first interaction module and a third service required by the first interaction module, the second description field describing a basic information of the first interaction module and callback functions related to the life cycle of the first interaction module; determining the first service and the third service by parsing the first description field; determining basic information of the first interaction module and callback functions related to the life cycle of the first interaction module by parsing the second description field; managing the life cycle of the first interaction module by using the basic information of the first interaction module and the callback functions related to the life cycle of the first interaction module; establishing a first mapping relationship between the first service and the third service; initiating a registration process for the first service according to the basic information of the first interaction module and the first mapping relationship. Through the first description field with the first general data structure, the registration process for the first service can be realized, and by the second description field with the second general data structure, the life cycle management for the first interaction module can be realized.

In some embodiments, the method comprises: receiving configuration information of the first interaction module, wherein the configuration information of the first interaction module includes a first description field with a first general data structure and a second description field with a second general data structure, the first description field describing the first service provided by the first interaction module and a third service required by the first interaction module, the second description field describing a basic information of the first interaction module and callback functions related to the life cycle of the first interaction module; determining the first service and the third service by parsing the first description field; determining basic information of the first interaction module and callback functions related to the life cycle of the first interaction module by parsing the second description field; managing the life cycle of the first interaction module by using the basic information of the first interaction module and the callback functions related to the life cycle of the first interaction module; establishing a first mapping relationship between the first service and the third service; initiating a registration process for the first service according to the basic information of the first interaction module and the first mapping relationship; receiving configuration information of the second interaction module, wherein the configuration information of the second interaction module includes a third description field with the first general data structure and a fourth description field with the second general data structure, the third description field describing the second service provided by the second interaction module and a fourth service required by the second interaction module, the fourth description field describing a basic information of the second interaction module and callback functions related to the life cycle of the second interaction module; determining the second service and the fourth service by parsing the third description field; determining basic information of the second interaction module and callback functions related to the life cycle of the second interaction module by parsing the fourth description field; managing the life cycle of the second interaction module by using the basic information of the second interaction module and the callback functions related to the life cycle of the second interaction module; establishing a second mapping relationship between the second service and the fourth service; initiating a registration process for the second service according to the basic information of the second interaction module and the second mapping relationship. Therefore, through the first description field with the first general data structure, a unified registration process for the first service and the second service can be realized. Through the second description field with the second general data structure, a unified life cycle management for the first interaction module and the second interaction module can be realized. A unified configuration is realized for industrial field equipment that adopts standard protocols or non-standard protocols.

In some embodiments, the method comprises: performing authentication processing on a requesting party requesting access to the registered first service or the registered second service. It can be seen that the authentication processing of the requesting party is also realized, which improves the security.

In some embodiments, the method comprises: storing persistently a first industrial data obtained by the first interaction module from the first industrial field device and a second industrial data obtained by the second interaction module from the second industrial field device, in a memory; performing data analysis on the first industrial data and the second industrial data in the memory in response to a data analysis request received via the Web server. Therefore, data storage services and data analysis services are also provided.

The modular data integration solution proposed by this embodiment provides a fast, efficient, and low-cost solution to help industrial enterprises quickly collect and integrate data from field devices, and then make correct decisions, including the following potential advantages:
(1) Cost-effectiveness. There is no need to change the existing field devices, only the specific connection module of the field device needs to be customized to interact with the field device. Provide local standard modules to directly exchange data with field devices that support standard protocols.
(2) High scalability. Provide a unified module data structure, life cycle management and service discovery interface, which is convenient for enterprises to customize modules. After the module is customized and implemented, it can be dynamically loaded without restarting the platform. Similarly, if the underlying device is removed or malfunctions, the module can be dynamically uninstalled from the platform.
(3) High safety. Provide secure access methods to protect the platform and field devices. The upper business layer or external applications can only interact with the platform through a unified restful API and OAuth. This method can prevent direct access to the underlying field devices and improve security.
(4) High flexibility. Two different deployment modes are provided, cluster mode and center mode, depending on the scale of the industrial plant.

In some embodiments, the user-level module has a unified data structure, life cycle management and service discovery interface. Following local standard module examples, specific modules can be customized and implemented for field devices with less effort. User-level modules inherit and implement a unified life cycle management interface, and the system life cycle management module can call related interfaces at different stages of the module life cycle. It provides a plug and play mode. In addition, the integrated Web server provides restful APIs for external business applications.

The back-end function of the Web server can be implemented in the authentication module. When the user-level module is dynamically loaded or unloaded from the platform, the service discovery module discovers all user services implemented in the user-level module, and then registers all services to the service provision module or deregisters all services from the service provision module. Once the http request arrives, the service provider module deserializes the request and converts it into an internal request. Since the service provider module stores all user service registrations, it can send internal requests to the correct user-level module, and then trigger the user-level module to collect data from the underlying field devices or send control commands to the underlying field devices.

At the same time, the service providing module serializes the internal response into the http response of the external business application. This method only provides a single point of access to external applications. In addition, the authentication module provides an identity verification and authorization mechanism to prevent unauthorized restful access. In addition, the platform of this embodiment is based on a modular architecture, and modules can be enabled or disabled according to actual needs. According to the scale of the industrial plant, the platform can deploy some modules in the management node in a cluster mode and deploy some modules in the field monitoring node. Or in the central mode, the module is deployed in the all-in-one field monitoring node.

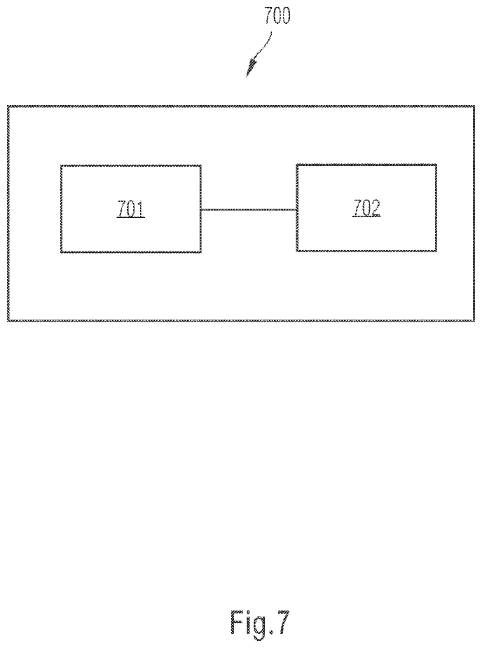

This embodiment includes an industrial data integration device with a processor-memory architecture. FIG. 7 is a structural diagram of an industrial data integration device with a processor-memory architecture incorporating teachings of the present disclosure. As shown in FIG. 7, the industrial data integration device 700 includes a processor 701, a memory 702, and a computer program stored on the memory 702 and running on the processor 701. When the computer program is executed by the processor 701, any of the above industrial data integration methods.

The memory 702 may be specifically implemented as various storage media such as an electrically erasable programmable read-only memory (EEPROM), a flash memory (Flash memory), and a programmable program read-only memory (PROM). The processor 701 may be implemented to include one or more central processing units or one or more field programmable gate arrays, where the field programmable gate array integrates one or more central processing unit cores. In some embodiments, the central processing unit or central processing unit core may include a CPU, MCU, or DSP, and so on.

It should be noted that not all steps and modules in the above-mentioned processes and structural diagrams are necessary, and some steps or modules can be omitted according to actual needs. The order of execution of each step is not fixed and can be adjusted as needed. The division of each module is just to facilitate the description of the functional division. In actual implementation, a module can be implemented by multiple modules, and the functions of multiple modules can also be implemented by the same module. These modules can be located in the same device. It can also be located in a different device.

The hardware modules can be implemented in a mechanical way or an electronic way. For example, a hardware module may include specially designed permanent circuits or logic devices (such as dedicated processors, such as FPGAs or ASICs) to complete specific operations. The hardware module may also include programmable logic devices or circuits temporarily configured by software (for example, including general-purpose processors or other programmable processors) for performing specific operations. As for the specific use of mechanical methods, or the use of dedicated permanent circuits, or the use of temporarily configured circuits (such as software configuration) to implement hardware modules, it can be determined according to cost and time considerations.

The above are only example embodiments of the present disclosure, and are not used to limit the protection scope thereof. Any modification, equivalent replacement, improvement, etc. made within the spirit and principle should be included in the protection scope of the present disclosure.

What is claimed is:

1. An industrial data integration device comprising:
a first interaction module to interact with a first industrial field device based on a non-standard protocol;
a life cycle management module to manage a life cycle of the first interaction module; and
a service discovery module to discover a first service provided by the first interaction module;
wherein the first service is related to an interaction between the first interaction module and the first industrial field device.

2. The device according to claim 1, further comprising:
a second interaction module to interact with a second industrial field device based on a standard protocol;
wherein the life cycle management module is further configured to manage a life cycle of the second interaction module;
the service discovery module is further configured to discover a second service provided by the second interaction module; and
the second service is related to the interaction between the second interaction module and the second industrial field device.

3. The device according to claim 1, further comprising:
a service providing module to register the first service or the second service and to provide the registered first service or the registered second service via a Web server.

4. The device according to claim 1, wherein:
the life cycle management module is configured to receive configuration information of the first interaction module;
the configuration information of the first interaction module includes a first description field with a first general data structure and a second description field with a second general data structure;
the first description field describes the first service provided by the first interaction module and a third service required by the first interaction module;
the second description field describes a basic information of the first interaction module and callback functions related to the life cycle of the first interaction module;
the life cycle management module is configured to determine the first service and the third service by parsing the first description field;
the life cycle management module is configured to determine basic information of the first interaction module and callback functions related to the life cycle of the first interaction module by parsing the second description field;
the life cycle management module is configured to manage the life cycle of the first interaction module by using the basic information of the first interaction module and the callback functions related to the life cycle of the first interaction module; and
the service discovery module is configured to establish a first mapping relationship between the first service and the third service and initiate a registration process for the first service according to the basic information of the first interaction module and the first mapping relationship.

5. The device according to claim 2, wherein:
the life cycle management module is configured to receive configuration information of the first interaction module;
the configuration information of the first interaction module includes a first description field with a first general data structure and a second description field with a second general data structure;
the first description field describes the first service provided by the first interaction module and a third service required by the first interaction module;
the second description field describes a basic information of the first interaction module and callback functions related to the life cycle of the first interaction module;
the life cycle management module is configured to determine the first service and the third service by parsing the first description field;
the life cycle management module is configured to determine basic information of the first interaction module and callback functions related to the life cycle of the first interaction module by parsing the second description field; and
the life cycle management module is configured to manage the life cycle of the first interaction module using the basic information of the first interaction module and the callback functions related to the life cycle of the first interaction module;
the service discovery module is configured to establish a first mapping relationship between the first service and the third service and initiate a registration process for the first service according to the basic information of the first interaction module and the first mapping relationship;
the life cycle management module is configured to receive configuration information of the second interaction module;
the configuration information of the second interaction module includes a third description field with the first general data structure and a fourth description field with the second general data structure;
the third description field describes the second service provided by the second interaction module and a fourth service required by the second interaction module;
the fourth description field describes a basic information of the second interaction module and callback functions related to the life cycle of the second interaction module;
the life cycle management module is configured to determine the second service and the fourth service by parsing the third description field;
the life cycle management module is configured to determine basic information of the second interaction module and callback functions related to the life cycle of the second interaction module by parsing the fourth description field;
the life cycle management module is configured to manage the life cycle of the second interaction module using the basic information of the second interaction module and the callback functions related to the life cycle of the second interaction module; and
the service discovery module is configured to establish a second mapping relationship between the second service and the fourth service and initiate a registration process for the second service according to the basic information of the second interaction module and the second mapping relationship.

6. The device according to claim 3, further comprising
an authentication module to perform authentication processing on a requesting party requesting access to the registered first service or the registered second service.

7. The device according to claim 3, further comprising:
a storage module to store first industrial data obtained by the first interaction module from the first industrial field device and second industrial data obtained by the second interaction module from the second industrial field device in a memory;
a data analysis module to perform data analysis on the first industrial data and the second industrial data stored in the memory in response to a data analysis request received via the Web server.

8. An industrial data integration method comprising:
enabling a first interaction module to interact with a first industrial field device based on a non-standard protocol;
managing a life cycle of the first interaction module; and
discovering a first service provided by the first interaction module;
wherein the first service is related to the interaction between the first interaction module and the first industrial field device.

9. The method according to claim 8, further comprising:
enabling a second interaction module to interact with a second industrial field device based on a standard protocol;
managing a life cycle of the second interaction module; and
discovering a second service provided by the second interaction module;
wherein the second service is related to the interaction between the second interaction module and the second industrial field device.

10. The method according to claim 8, further comprising:
registering for the first service or the second service; and
providing registered first service or registered second service via web server.

11. The method according to claim 8, further comprising:
receiving configuration information of the first interaction module;
wherein the configuration information of the first interaction module includes a first description field with a first general data structure and a second description field with a second general data structure, the first description field describing the first service provided by the first interaction module and a third service required by the first interaction module, the second description field describing a basic information of the first interaction module and callback functions related to the life cycle of the first interaction module;
determining the first service and the third service by parsing the first description field;
determining basic information of the first interaction module and callback functions related to the life cycle of the first interaction module by parsing the second description field;
managing the life cycle of the first interaction module by using the basic information of the first interaction module and the callback functions related to the life cycle of the first interaction module;
establishing a first mapping relationship between the first service and the third service; and
initiating a registration process for the first service according to the basic information of the first interaction module and the first mapping relationship.

12. The method according to claim 9, further comprising:
receiving configuration information of the first interaction module;
wherein the configuration information of the first interaction module includes a first description field with a first general data structure and a second description field with a second general data structure, the first description field describing the first service provided by the first interaction module and a third service required by the first interaction module, the second description field describing a basic information of the first interaction module and callback functions related to the life cycle of the first interaction module;
determining the first service and the third service by parsing the first description field;
determining basic information of the first interaction module and callback functions related to the life cycle of the first interaction module by parsing the second description field;
managing the life cycle of the first interaction module by using the basic information of the first interaction module and the callback functions related to the life cycle of the first interaction module;
establishing a first mapping relationship between the first service and the third service;
initiating a registration process for the first service according to the basic information of the first interaction module and the first mapping relationship;
receiving configuration information of the second interaction module, wherein the configuration information of the second interaction module includes a third description field with the first general data structure and a fourth description field with the second general data structure, the third description field describing the second service provided by the second interaction module and a fourth service required by the second interaction module, the fourth description field describing a basic information of the second interaction module and callback functions related to the life cycle of the second interaction module;
determining the second service and the fourth service by parsing the third description field;
determining basic information of the second interaction module and callback functions related to the life cycle of the second interaction module by parsing the fourth description field;
managing the life cycle of the second interaction module by using the basic information of the second interaction module and the callback functions related to the life cycle of the second interaction module;
establishing a second mapping relationship between the second service and the fourth service; and
initiating a registration process for the second service according to the basic information of the second interaction module and the second mapping relationship.

13. The method according to claim 10, further comprising
performing authentication processing on a requesting party requesting access to the registered first service or the registered second service.

14. The method according to claim 10, further comprising:
storing persistently a first industrial data obtained by the first interaction module from the first industrial field device and a second industrial data obtained by the second interaction module from the second industrial field device, in a memory; and
performing data analysis on the first industrial data and the second industrial data in the memory in response to a data analysis request received via the Web server.

15. An industrial data integration device comprising:
a processor; and
a memory storing an application program executable by the processor;
wherein the program directs the processor to execute an industrial data integration method comprising:
enabling a first interaction module to interact with a first industrial field device based on a non-standard protocol;
managing a life cycle of the first interaction module; and
discovering a first service provided by the first interaction module;
wherein the first service is related to the interaction between the first interaction module and the first industrial field device.

16. (canceled)
